(19) United States
(12) Patent Application Publication
(10) Pub. No.: US 2013/0151020 A1
(43) Pub. Date: Jun. 13, 2013

(54) MEASUREMENT ARRANGEMENT FOR FIELD DEVICES

(71) Applicants: Timo P. Manninen, Helsinki (FI); Sami Hakulinen, Helsinki (FI)

(72) Inventors: Timo P. Manninen, Helsinki (FI); Sami Hakulinen, Helsinki (FI)

(73) Assignee: METSO AUTOMATION OY, Vantaa (FI)

(21) Appl. No.: 13/806,454

(22) PCT Filed: Jun. 30, 2010
(86) PCT No.: PCT/FI10/50561

§ 371 Date: Feb. 15, 2013

(51) Int. Cl. G05D 7/00

(52) U.S. Cl. CPC G05D 7/00
USPC 700/282

(57) ABSTRACT

Disclosed are sensors to measure predetermined process variables in the process pipeline and to transmit measurement data over wired automation lines to the automation system for process automation purposes. A wireless measurement transmitter is connected to the wired automation line between the sensor and the automation system. WMT is configured to intercept or tap the measurement data transferred on the automation line and to transmit the tapped measurement data over a wireless connection to an intelligent control valve for local control and/or diagnosis procedures performed at the intelligent control valve.

### FIELD OF THE INVENTION

The present invention relates generally to field devices.

### BACKGROUND OF THE INVENTION

A control valve is generally used for a continuous control of a liquid or gas flow in different pipelines and processes. In a processing industry, such as pulp and paper, oil refining, petrochemical and chemical industries, different kinds of control valves installed in a plant's pipe system control material flows in the process. A material flow may contain any fluid material, such as fluids, liquors, liquids, gases and steam. The control valve is usually connected with an actuator, which moves the closing element of the valve to a desired open position between fully open and fully closed positions. The actuator may be a pneumatic cylinder-piston device, for example. The actuator, for its part, is usually controlled by a valve positioner, also called as a valve controller, which controls the position of the closing element of the control valve and thus the material flow in the process according to a control signal from the controller.

Processes are typically controlled by control loops/circuits. A control loop or circuit consists, for instance, of a process to be controlled, a control valve, a measuring device (e.g. sensor) and transmitter, and a controller. The controller gives the control valve a control signal as an analog current signal or a digital control message, for example. The measuring sensor measures a controlled variable, and the measurement result is fed back to the controller, where it is compared with a given reference value. Based on the deviation, the controller calculates the control for the control valve. Usually the controller functions in such a manner that it minimizes the deviation by a suitable control algorithm, such as a PI or PID algorithm. This control algorithm is typically tuned for each valve during mounting or operation.

The unit implementing the controller function may be implemented in a centralized process control computer, to which the measurement information is supplied from measuring devices (e.g. sensors) and other process devices. The process computer generates a control signal for a control valve and supplies it over a field bus or control line (such as a 4 to 20 mA current signal) to the control valve. The process control may also be distributed among several units in the automation process. Moreover, the process control may be implemented such that it is associated with or integrated into the control valve. With the latter approach a problem of an increased control delay, which may impair the control result with the central process controller approach, can be avoided or reduced. Examples of valve control arrangements using flow sensors or indicators are disclosed in WO2007/141386.

Loop performance is maintained only if all the components in the control loop function correctly. It is crucial to service valves at regular intervals in order to keep the process sufficiently efficient and to maintain loop performance throughout the whole life cycle. It is also essential to predict when control valves should be serviced. Servicing valves before it is actually required could work, but it would be a rather expensive and time consuming way of doing maintenance. Waiting until valves fail and cause a possible unscheduled shutdown can also be very costly. Ideally, only those valves that really require maintenance should be serviced during a shutdown. To accomplish this, advanced valve diagnostics and/or monitoring, including online and offline diagnostics, would have to be utilized.

Online diagnostics makes it possible to monitor valve performance while the process is running, not only during shutdowns. The aim of predictive maintenance is to indicate decreasing valve performance and to warn the user before failure is so bad that it causes excessive process variability or even an unexpected shutdown. Online diagnostics can continuously monitor valve performance, but analyzing the results can be very time consuming and labor intensive. The most efficient way to carry out predictive maintenance and online diagnostics is to utilize valve controllers, which are capable of storing results in their memory and send warnings and alarms based on performance limits stored in their memory. In this way, no additional manpower is needed to analyze and study the results continuously, because the intelligent valve controller, with the help of advanced asset management software, can measure valve performance automatically. An example of an intelligent valve controller with online diagnostics is ND9000® from Metso Automation Inc.

Valve monitoring and diagnostics methods using position sensors, pressure sensors, etc. are disclosed in copending applications PCT/F12010/050146 and PCT/F12010/050352.

WO2008/078323 discloses a system for monitoring “dumb” valves by affixing a wireless monitoring device to the valve in a manner which does not disturb the normal operation of the valve. The monitoring device has a wireless communication link to a data reading device in the control system infrastructure. Wireless flow, pressure, and temperature sensors in the vicinity of the valve are connected to the monitoring device by short range wireless links for sending measurement data at predetermined times. The monitoring device sends the sensor measurement data to the data reading device. The wireless communication eliminates the need for expensive wiring which is said to be one of the most frequent sources of failure in the process line.

U.S. Pat. No. 6,751,575 discloses monitoring and diagnosing process devices by collecting measured process variables and test results into a history database to be compared with process attribute information stored in databases.

### SUMMARY OF THE INVENTION

An object of the present invention is to provide new measurement arrangement for controlling and/or diagnosing field devices, particularly control valves. This object of the invention is achieved by the subject matter of the attached independent claims. The preferred embodiments of the invention are disclosed in the dependent claims.

An aspect of the invention is a measurement arrangement for a field device, particularly a control valve, in a process automation system comprising,

a measuring device connected to a process automation computer system over a first wired connection and arranged to measure a predetermined process variable in a process and send measurement data to the process automation computer system over the first wired connection,

an field device connected to the process automation computer system over a second connection,

a wireless tapping transmitter connected to the first wired connection and arranged to tap the measurement data transferred on the first wired connection and to transmit the tapped measurement data over a third wireless connection to the intelligent field device for local control and/or diagnosis procedures performed at the intelligent field device.

According to an embodiment, the measurement data transferred on the first wired connection is in form of an analog current or voltage signal, preferably a 4-20 mA current signal.

According to an embodiment, the wireless tapping transmitter comprises analog-to-digital converter arranged to convert the tapped analog measurement signal into a digital format for the wireless transmission to the intelligent field device.

According to an embodiment, the measurement data transferred on the first wired connection using a field bus protocol.

According to an embodiment, the intelligent field device comprises a wireless receiver arranged to receive the tapped measurement data over the third wireless connection, and a processing unit arranged to use the received tapped measurement data for controlling and/or diagnosing the operation of the intelligent field device or any component thereof.

According to an embodiment, the processing unit is arranged to process and/or store the received tapped measurement data and provide diagnostics data to the process automation computer system or a centralized diagnostics system over the second wired connection or a further connection.

According to an embodiment, the arrangement comprises a shared resource unit having an extended data processing and/or data storage capacity and connected by wireless connections to a plurality of intelligent field devices, the shared data resource unit providing data processing and/or services to said plurality of intelligent field devices in response to service requests sent by said plurality of intelligent field devices.

According to an embodiment, said shared resource unit is arranged to operate as wireless router between the wireless tapping transmitter and the intelligent field device.

According to an embodiment, the arrangement comprises a plurality of further wireless tapping transmitters each connected a respective further first wired connection and arranged to tap a measurement data transferred on the respective first wired connection and to transmit the tapped measurement data over a respective third wireless connection to the intelligent field device for local control and/or diagnosis procedures performed at the intelligent field device.

According to an embodiment, the wireless tapping transmitter is arranged to wirelessly send the tapped measurement data to more than one intelligent field device.

According to an embodiment, said predetermined process variable is one of temperature, flow rate and pressure.

Another aspect of the invention is an intelligent field device, particularly a control valve, connected to a process automation computer system over a second wired connection and comprising a wireless receiver arranged to receive from a wireless tapping transmitter over a third wireless connection a process variable measurement data tapped from a first wired connection between the process automation system and a measurement device sensing the process variable in the process, and the intelligent field further comprising a processing unit arranged to use the received tapped measurement data for controlling and/or diagnosing the operation of the intelligent field device or any component or subprocess thereof.

A further aspect of the invention is an intelligent wireless transmitter, comprising

a first interface configured to be connected to a first wired connection between a process automation system and a measurement device sensing a predetermined process variable in a process,

said wireless transmitter being arranged to tap measurement data transferred on the first wired connection and to transmit the tapped measurement data over a third wireless connection to an intelligent field device, particularly a control valve, which is connected to a second wired connection, to be used in local control and/or diagnosis procedures performed at the intelligent field device.

According to an embodiment, the measurement data transferred on the first wired connection is in form of an analog current or voltage signal, preferably a 4-20 mA current signal.

According to an embodiment, the wireless transmitter comprises analog-to-digital converter arranged to convert the tapped analog measurement signal into a digital format for the wireless transmission to the intelligent field device.

### BRIEF DESCRIPTION OF THE DRAWINGS

In the following the invention will be described in greater detail by means of exemplary embodiments with reference to the attached drawings, in which

FIG. 1 shows a schematic block diagram of an exemplary process automation system and a field device management system wherein the principles of the present invention may be applied;

FIG. 2 shows a schematic block diagram of an exemplary process automation system provided with wireless measurement transmitters according to embodiments of the invention;

FIG. 3 shows a schematic block diagram of an exemplary wireless measurement transmitter according to an embodiment of the invention; and

FIG. 4 shows a schematic block diagram of an exemplary intelligent valve controller according to an embodiment of the invention.

### EXAMPLE EMBODIMENTS OF THE INVENTION

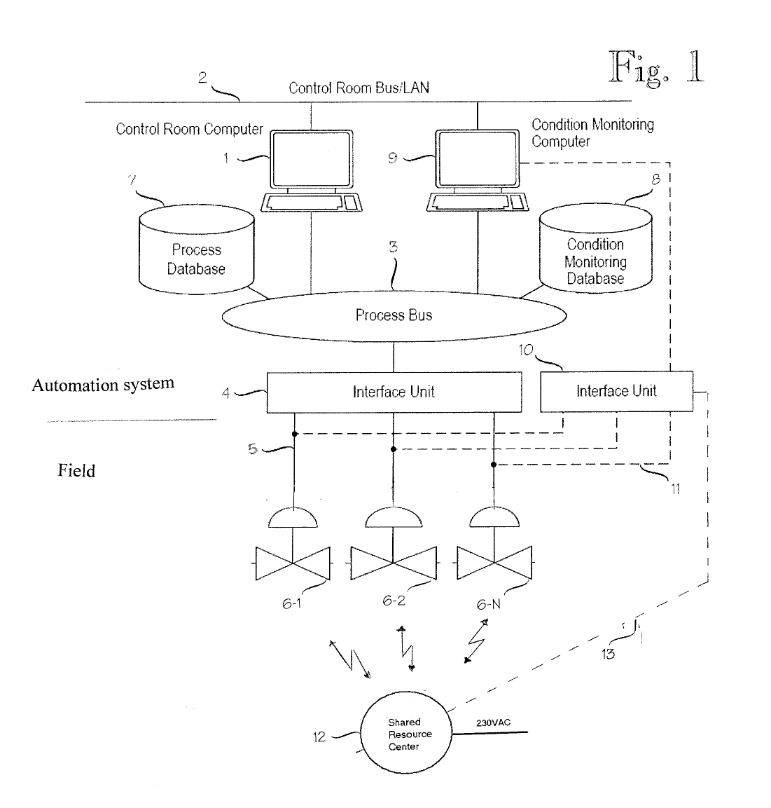

The present invention can be applied in diagnosis and/or control of any control valves, and the components thereof, in any automation system for any industrial process and the like. FIG. 1 schematically illustrates an exemplary automation system, to which the example embodiments of the invention may be applied. The central processing unit of the automation system controlling the productive activity of an entire factory, such as a paper mill, is typically a control room, which is composed of one or more control room computers 1, for example. The control room computer block 1 generally represents any and all control room computer(s)/programs and process control computer(s)/programs as well as databases in the automation system. There are various architectures for a control system. For example, the control system may be a Direct Digital Control (DDC) system or a Distributed Control System (DCS), both well known in the art. Good example of a new generation automation and information platform is is metsoDNA CR delivered by Metso. The automation system may comprise a process bus/network 3 and/or a control room bus/network 2, by which different process control components or computers are coupled to one another. The control room bus/network 2 may interconnect the user interface components of the automation system. The control room bus/network 2 may be a local area network, for example, based on the standard Ethernet technology. The process bus/network 3 may, in turn, interconnect the process control components. The process bus/network 3 may be based on a deterministic token passing protocol, for instance. Process controllers may also be connected to the control room network 2, allowing the communication between the process controllers and the user interfaces. It must be appreciated, however, that FIG. 1 only illustrates one example of an automation system and it is not the intention to limit the application area of the invention to any specific implementation of an automation system.

There are various alternative ways to arrange the interconnection between the control system and field devices, such as control valves, in a plant area. Traditionally, field devices have been connected to the control system by two-wire twisted pair loops, each device being connected to the control system by a single twisted pair providing a 4 to 20 mA analog input signal. More recently, new solutions, such as Highway Addressable Remote Transducer (HART) protocol, that allow the transmission of digital data together with the conventional 4 to 20 mA analog signal in the twisted pair loop have been used in the control systems. The HART protocol is described in greater detail for example in the publication HART Field Communication Protocol: An Introduction for Users and Manufacturers, HART Communication Foundation, 1995. The HART protocol has also been developed into an industrial standard. Other examples of fieldbuses are Fieldbus and Profibus.

In the example architecture of FIG. 1, the process network 3 may also be connected with one or more interface units or I/O (input/output) units 4, to which fieldbuses or other field connection lines 5 are connected. The automation lines 5 connect individual field devices, such as actuators, valves, pumps and measuring devices (e.g. sensors), in the field to the control room computers. In the illustrated example, the field devices shown are control valves 6-1, 6-2, . . . 6-N. Further, in the illustrated examples the filed connection lines carry analog signals, preferably 4 to 20 mA analog signals, as such or in combination with a suitable fieldbus protocol, such as HART. However, it is to be understood that the type or implementation of the interconnection between the control room and the field devices may be based on any one of the alternatives described above, or on any combination of the same, or on any other implementation. A practical plant configuration may, and typically does, include several types of field connection lines or fieldbuses in parallel, since the plant is updated and extended gradually over a long period of time.

A field device may be, for example, a control valve connected to a process to control the flow of a substance in process pipeline. The material flow may contain any fluid material, such as fluids, liquors, liquids, gases and steam. An intelligent control valve is provided with an intelligent valve controller. An example of such an intelligent valve controller is Neles ND9000 manufactured by Metso. The operation of an intelligent valve controller may be based on a microcontroller, such as a microprocessor (μP), which controls the position of the valve on the basis of control information obtained from the field connection line or fieldbus 5. The valve controller is preferably provided with valve position measurement, in addition to which it is possible to measure many other variables, such as supply pressure for pressurized air, pressure difference over actuator piston or temperature, which may be necessary in the self-diagnostics of the valve or which the valve controller transmits as such or as processed diagnostic information to the control room computer, process controller, condition monitoring computer or a similar higher-level unit of the automation system via a field bus.

The automation system according to the example embodiment of FIG. 1 is also connected with a condition monitoring computer 9 monitoring the condition of the intelligent control valves. The condition monitoring computer 9 may be a part of the automation system, in which case it preferably communicates with the field devices via the process bus 3 and the field connection lines or fieldbuses 5. Although the condition monitoring computer 9 is shown as a separate device in FIG. 1, it may also be a part of the control room computer or software of the automation system or of some other station or software of the automation system. The condition monitoring computer 9 may also be separate from the automation system, in which case it may be connected to the fieldbuses via its own interface unit 10 (such as a HART multiplexer for HART field devices or an ISA or PCI card or an ISA or PCI gateway for PROF IBUS field devices), the I/O port/ports 11 of which is/are connected (broken lines 11 represent interface buses) to the field connection lines or field bus/buses 5 and the other side of which is connected via a suitable data bus to the condition monitoring computer 9. The condition monitoring computer 9 may collect diagnostics information and status information provided by the field devices and warn the user of potential problems before they harm the process. Each field device may provide the information on its status itself and the condition monitoring computer reads this information from the field device via a fieldbus. An example of this type of monitoring computer or software is Field-Care™ software delivered by Metso.

In addition to measurements inside the valve, process measurements may be used in the condition monitoring (diagnosis) and/or control of an intelligent control valve. For example, a flow rate through the valve, a pressure difference over the valve, or temperature of the fluid in a pipeline may be useful information for valve control or diagnosis. These process variables can be measured with dedicated measuring devices (e.g. sensors) associated with the valves. These process variables are typically measured also by sensors of the automation system and they may be available in the automation system, such as in the control room computer 1 and the process database 7.

However, these process measurement data cannot be efficiently utilized in diagnosis of control valve applications. For example, the routing of these process measurement data to a diagnosis system of the intelligent control valves, such as the condition monitoring computer 9, is difficult and complicated, since that would require configuration (programming) of the automation system and the user interface thereof. As the vendor of the automation system and the vendor of the field devices are often different instances, such configuring or programming is often difficult to perform by the vendor of the field devices. As a result, a maintenance personnel or plant operators who wish to diagnose valve applications (such as valve-pump systems) must open both a view of the process measurements at the user interface of the automation system and a view of the valve measurements at the user interface of the valve monitoring system, and then make the diagnosis of the condition of the valve application based on these different user-interface views.

The automation system 1 may utilize these process measurement data in controlling the operation of the control valve. The process measurements are performed by measuring (e.g. sensor) devices installed in the field of the plant. The measurement data is then transmitted to the process automation computer system 1 over a suitable connection, typically using 4 to 20 mA analog signal. The automation computer system 1 then performs an appropriate control function and transmits a control signal to a control valve over a suitable connection, typically using 4 to 20 mA analog signal.

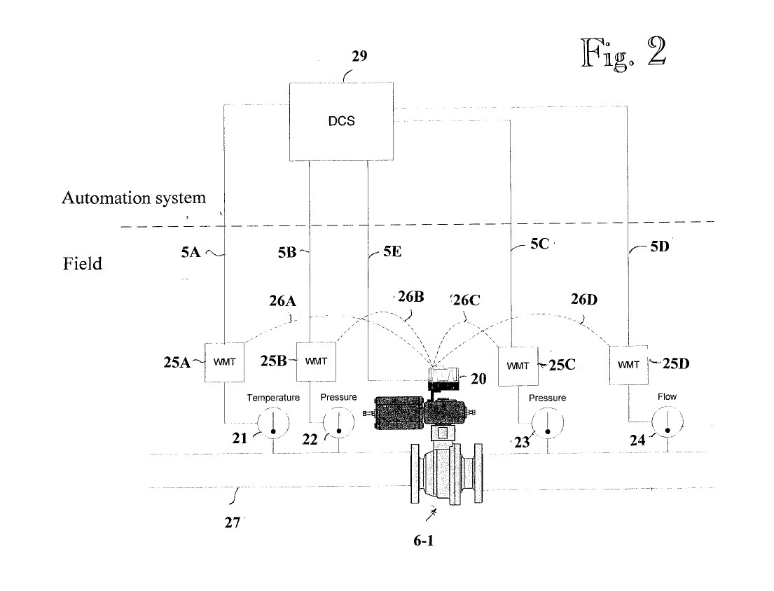

Exemplary embodiments of the invention will now be described with reference to FIG. 2. In the example of FIG. 2, the control block 29 (DCS) generally represents any automation system that controls field devices, i.e. such as actuators, valves, pumps, measuring devices and sensors, etc. installed in the process plant (field). Such an automation system may be similar to that described and illustrated with reference to FIG. 1. In the exemplary embodiment shown in FIG. 2, one intelligent control valve 6-1 (e.g. the control valve 6-1 shown in FIG. 1) is illustrated as being installed in a process pipeline 27 to control a flow of a process fluid in the pipeline 27. The intelligent control valve 6-1 may also comprise an intelligent valve controller, such as Neles ND9000 manufactured by Metso. The intelligent control valve 6-1, particularly the intelligent valve controller 20 thereof, is connected to the automation system 29 (e.g. to the interface unit 4 shown in FIG. 1) over a wired connection 5E. In the illustrated example, the field connection line carries an analog signal, preferably 4 to 20 mA analog signal, as such or in combination with a suitable field bus protocol, such as HART. However, it is to be understood that the type or implementation of the interconnection between the control room and the field devices may be based on any one of the alternatives described above, or on any combination of the same, or on any other implementation. Although only one intelligent control valve is shown in the illustrated example, it should be appreciated that any number of intelligent field devices may be provided in the process and used for the purposes of the present invention.

In the illustrated example, sensors 21, 22, 23 and 24 are provided to measure predetermined process variables in the process pipeline 27. The temperature sensor 21 is configured to measure the temperature of the process fluid in the pipeline 27 upstream from the control valve 6-1. The pressure sensors 22 and 23 are configured to measure the fluid pressure in the pipeline 27 upstream and downstream, respectively, from the control valve 6-1. The flow sensor (flow indicator) 27 is arranged to measure the flow rate of the process fluid downstream from the control valve. The sensors 21, 22, 23 and 24 are connected to the automation system 29 (e.g. to the interface unit 4 shown in FIG. 1) over wired automations lines 5A, 5B, 5C and 5D, respectively. In the illustrated example, the process control lines carry the measurement data as an analog signal, preferably 4 to 20 mA analog signal, as such or in combination with a suitable field bus protocol, such as HART. However, it is to be understood that the type or implementation of the interconnection between the automation system and the sensors or other measuring devices may be based on any one of the alternatives described above, or on any combination of the same, or on any other implementation. The implementation of the interconnection may also be different for different sensors or other measuring devices. Although four sensors are shown in the illustrated example, it should be appreciated that any number of sensors or measuring devices may be provided in the process and used for the purposes of the present invention.

The primary purpose of the sensors 21, 22, 23 and 24 is to provide process variable measurement data over field connection lines 5A, 5B, 5C and 5D to the automation system 29 for the purpose of process control. According to embodiments of the invention, a wireless measurement transmitter (WMT) 25A is connected to the field connection line 5A between the sensor 21 and the automation system 29. WMT 25A is configured to intercept or tap (“steal”, “eavesdrop”) the temperature measurement data transferred on the connection line 5A and to transmit the tapped measurement data over a wireless connection 26A to the intelligent control valve 6-1, particularly to the intelligent valve controller 20, for local control and/or diagnosis procedures performed at the intelligent control valve. Similarly, wireless measurement transmitters 25B, 25C and 25D are connected to the field connection lines 5B, 5C and 5D, respectively, between the automation system 29 and the sensors 22, 23 and 23, and configured to tap the measurement data transferred on the respective field connection line and to transmit the tapped measurement data over a wireless connection 26B, 26C and 26D, respectively, to the valve controller 20.

Thus, the process measurements of the automation system are wirelessly routed directly to the valve controller 20. According to embodiments of the invention, process measurement are provided for an intelligent control valve more cost efficiently, with minimal installation work, without configuration or programming work in the automation system, and with reduced measurement and/or control delay, while all arrangements can be made by the vendor of the intelligent control valve.

For example, for control valve diagnostics, the intelligent valve controller is able to process the received process measurement data and make self-diagnostics. Diagnostic results and/or measurement data (preferably processed data can be transferred to or interrogated by the maintenance personnel using the conditioning monitoring computer 9, for example, and all the relevant information (including the process measurement data) for the diagnosis can be available in a single view on a computer screen, which is an improvement in comparison with displaying the process measurement view in the automation system. No co-operation between the automation system 29 (e.g. control room computer 1) and the field device management system (e.g. the condition monitoring computer 9) may be required but the vendor of the control valve can provide the diagnosis system independently from the automation system or systems used. It is only required to tap the process measurement data provided by process sensors to the automation system for other purposes. This arrangement may be totally transparent to the automation system. The wireless measurement transmitters according to the invention can be connected to field connection lines and sensors or other measuring devices already existing in the field. No additional wiring or cabling is needed. The electrical power for the wireless measurement transmitters can be taken from the tapped field connection line. The tapping location along the field connection line can be freely selected to be optimal for the communication, e.g. to minimize the interference, the transmission power of the measurement transmitter, or the delay in the valve control due to routing/propagation time of the measurement data. Thus, various embedded flow control applications in the control valve are enabled, while avoiding dedicated process sensors for the control valve.

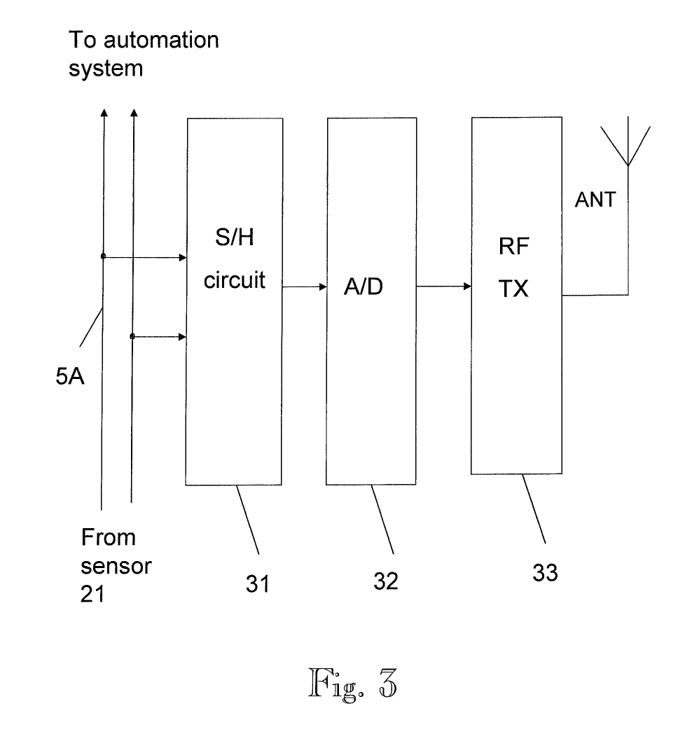

An exemplary embodiment of a wireless measurement transmitter (WMT) is illustrated in FIG. 3. All WMTs 25A-25D may be similar to each other but they may also differ from each other, depending on the type of the field connection line 5 or the type of the measurement data, for example. The WMT comprises an interface circuit 31 configured to be connected to the field connection line (e.g. line 5A) to intercept or tap the measurement data on the field connection line signal without interfering or loading the actual communication on the field connection line. Also the supply power for the WMT may be drained from the field connection line 5A. In the case the measurement data is carried by an analog signal, e.g. 4-20 mA current signal, the interface circuit 31 may be arranged to sample or measure the analog signal and provide an analog sample signal with a suitable input stage, such as a sample and hold (S/H) circuit that does not interfere or load the actual communication on the field connection line. The analog tapped signal may then be digitized by an appropriate analog-to-digital (A/D) converter circuitry. The digitized tapped measurement data is then transmitted by an appropriated radio frequency (RF) transmitter unit 33 via an antenna ANT. The RF unit 33 may implemented by any radio technology but it is preferably implemented by one of standard small-range radio communication technologies, such as Bluetooth or Zigbee. The tapped signal may also be transmitted in an analog format without prior ND conversion but this approach is more prone to interferences and errors. In the case the measurement data is obtained from a field communication protocol transferred on the field connection line 5A, the WMT may tap and transmit forward all signalling from the field connection line, or the WMT may comprise additional intelligence (e.g. a microcontroller) that is able to recognize and filter the relevant measurement data for transmission to the control valve. It should be appreciated that the illustrated wireless measurement transmitter is merely an example and the invention is not limited any specific implementation of a wireless measurement transmitter.

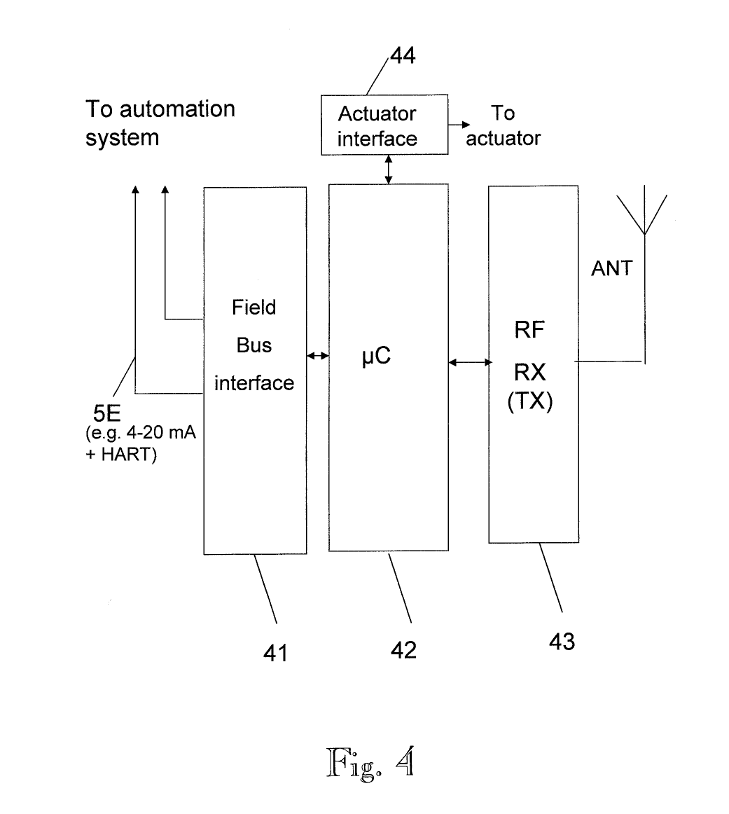

An example block diagram of microcontroller-based intelligent valve controller 20 is illustrated in FIG. 4. A microcontroller 42 controls the valve position. To that end, the controller unit 42, such as a micro controller, may receive an input signal (a set point) over an field connection line or fieldbus 5A, such as 4-20 mA pair and HART, via a field bus interface 41 and it may also perform various measurements. The device may be powered from a 4-20 mA or fieldbus. The devices and arrangement needed for controlling an actuator (not shown), which moves the actual valve, are generally depicted as an actuator interface 44 in FIG. 4. For a pneumatic actuator, for example, the actuator interface 44 may comprise a prestage (PR) spool for providing actuator pneumatic pressures to the pneumatic actuator, and inputs from a position sensor, a supply pressure sensor, actuator pressure sensors, and a spool position sensor SPS, and an output for a prestage (PR) coil current for moving spool to change the actuator pressures and thereby cause the actuator to move the valve. In accordance to exemplary embodiments, the valve controller also comprises a radio frequency (RF) receiver unit 43 and an antenna configured to receive tapped measurement data from one or more of wireless measurement transmitters (WMT) 25A-D over the wireless connections 26A-26D. The RF receiver unit 43 supplies the received tapped measurement data to the microcontroller 42 which may utilize the measurement data for local control and/or diagnosis procedures performed by the intelligent valve controller. For example, for control valve diagnostics, the intelligent valve controller may process the received process measurement data and make self-diagnostics. Diagnostic results and/or measurement data (preferably processed data may be transferred to the condition monitoring computer 9, for example, over the automation line or field bus 5E. It should be appreciated that the illustrated valve controller is merely an example and the invention is not limited any specific implementation of a valve controller.

According to a further aspect of the invention, a shared resource center or unit (SRC) 12 may be provided in the field (process plant) in close neighbourhood of intelligent control valves 6-1, 6-2 and 6-N. Intelligent valve controllers or positioners have very restricted resources of their own for computing, data storage, and like data processing. These restricted resources often prevent application of sophisticated diagnostic and control methods and algorithms which require significant computing power and memory capacity. The shared resource center (SRC) 12 may be located in the field centrally in relation to the process segment, and it may provide the neighbouring valve controllers with extended data processing, computing and/or data storage resources. Communication between the SRC 12 and the valve controllers may be implemented by any suitable communication media, wired or wireless. Wireless communication is more cost efficient as the additional cabling is avoided. The SRC 12 may then also operate as a wireless relay or router between different field devices, such as between the wireless measurement transmitters (WMT) 25A-25D and the intelligent control valves. The SRC 12 may also directly utilize in the diagnosis computing or in another way the tapped process measurement data received from the WMTs 25A-25D.

Tthe SRC 12 may offer computing services for simulating a model in a model-based valve diagnostics, for example. The valve controller requesting the service then sends the necessary parameter values to the SRC 12 which, after the computing process based on these values, returns the simulation results to the SRC 12. The simulation result may be, for example, an indication whether the simulation result differs from the real measurements, i.e. whether the valve arrangement is not working properly. The SRC 12 may also deliver the diagnosis result directly to the condition monitoring computer 9 or like over an appropriate field connection 13. The SRC 12 may also store the diagnostic data in its memory and/or send compressed diagnostics data (such as present trends) to the valve controller to be stored in the memory of the microprocessor. Similarly, in sophisticated control strategies there may occasionally be need for updating the control model, which requires significantly computing resources.

The shared resource center (SRC) 12 may also comprise a database on characteristics and features of the installed control valves, such as Cv curves, which, when needed, are available to the control valves in a desired manner, such as the entire Cv curve according to the type of the valve, or a corresponding Cv value based on the position data. More generally, any database features or database updates can be made available to the valve controllers or positioners which inherently have very restricted resources.

The description and the related figures are only intended to illustrate the principles of the present invention by means of examples. Various alternative embodiments, variations and changes are obvious to a person skilled in the art on the basis of this description. The present invention is not intended to be limited to the examples described herein but the invention may vary within the scope and spirit of the appended claims.

1. A measurement arrangement for a field device, particularly a control valve, in a process automation system comprising,
a measuring device connected to a process automation computer system over a first wired connection and arranged to measure a predetermined process variable in a process and send measurement data to the process automation computer system over the first wired connection,
an field device connected to the process automation computer system over a second connection,
a wireless tapping transmitter connected to the first wired connection and arranged to tap the measurement data transferred on the first wired connection and to transmit the tapped measurement data over a third wireless connection to the intelligent field device for local control and/or diagnosis procedures performed at the intelligent field device.

2. An arrangement according to claim 1, wherein the measurement data transferred on the first wired connection is in form of an analog current or voltage signal, preferably a 4-20 mA current signal.

3. Arrangement according to claim 2, wherein the wireless tapping transmitter comprises analog-to-digital converter arranged to convert the tapped analog measurement signal into a digital format for the wireless transmission to the intelligent field device.

4. An arrangement according to claim 1, wherein the measurement data transferred on the first wired connection using a field bus protocol.

5. An arrangement according to claim 1, wherein the intelligent field device comprises a wireless receiver arranged to receive the tapped measurement data over the third wireless connection, and a processing unit arranged to use the received tapped measurement data for controlling and/or diagnosing the operation of the intelligent field device or any component thereof.

6. An arrangement according claim 5, wherein the processing unit is arranged to process and/or store the received tapped measurement data and provide diagnostics data to the process automation computer system or a centralized diagnostics system over the second wired connection or a further connection.

7. An arrangement according to claim 5, comprising a shared resource unit having an extended data processing and/or data storage capacity and connected by wireless connections to a plurality of intelligent field devices, the shared data resource unit providing data processing and/or services to said plurality of intelligent field devices in response to service requests sent by said plurality of intelligent field devices.

8. An arrangement according to claim 7, wherein said shared resource unit is arranged to operate as wireless router between the wireless tapping transmitter and the intelligent field device.

9. An arrangement according claim 1, comprising a plurality of further wireless tapping transmitters each connected a respective further first wired connection and arranged to tap a measurement data transferred on the respective first wired connection and to transmit the tapped measurement data over a respective third wireless connection to the intelligent field device for local control and/or diagnosis procedures performed at the intelligent field device.

10. An arrangement according to claim 1, wherein the wireless tapping transmitter is arranged to wirelessly send the tapped measurement data to more than one intelligent field device.

11. An arrangement according to claim 1, wherein said predetermined process variable is one of temperature, flow rate and pressure.

12. An intelligent field device, particularly a control valve, connected to a process automation computer system over a second wired connection and comprising a wireless receiver arranged to receive from a wireless tapping transmitter over a third wireless connection a process variable measurement data tapped from a first wired connection between the process automation system and a measurement device sensing the process variable in the process, and the intelligent field further comprising a processing unit arranged to use the received tapped measurement data for controlling and/or diagnosing the operation of the intelligent field device or any component or subprocess thereof.

13. A wireless transmitter, comprising
a first interface configured to be connected to a first wired connection between a process automation system and a measurement device sensing a predetermined process variable in a process,
said wireless transmitter being arranged to tap measurement data transferred on the first wired connection and to transmit the tapped measurement data over a third wireless connection to an intelligent field device, particularly a control valve, which is connected to a second wired connection, to be used in local control and/or diagnosis procedures performed at the intelligent field device.

14. A wireless transmitter according to claim 13, wherein the measurement data transferred on the first wired connection is in form of an analog current or voltage signal, preferably a 4-20 mA current signal.

15. A wireless transmitter according to claim 14, wherein the wireless transmitter comprises analog-to-digital converter arranged to convert the tapped analog measurement signal into a digital format for the wireless transmission to the intelligent field device.
